(19) United States
(12) Patent Application Publication
(10) Pub. No.: US 2016/0093240 A1
(43) Pub. Date: Mar. 31, 2016

(54) System for Varying Light Output in a Flexible Display

(71) Applicant: Dell Products, LP, Round Rock, TX (US)

(72) Inventors: Deeder M. Aurongzeb, Austin, TX (US); Lawrence E. Knepper, Leander, TX (US)

(21) Appl. No.: 14/502,694

(22) Filed: Sep. 30, 2014

(51) Int. Cl. G09G 3/20; G09G 3/32

(52) U.S. Cl. CPC G09G 3/2003; G09G 3/3208

(57) ABSTRACT

Display data is altered for a flexed portion of a flexible display. A stress amount (e.g., hinge angle) is detected for the affected region of the display. Based on the stress amount and location of the stress, a color mapping is changed to cause the affected portion to display as desired, for example to display consistently with other portions of the display. Viewing angle can be detected and used to further change the color mapping for the affected region. Changing the color mapping may be based on empirical data stored for known stresses for the display or similar displays.

### FIELD OF THE DISCLOSURE

The present disclosure generally relates to displays for information handling systems, and more particularly to varying light output in a flexible display based on the flexed state of the flexible display.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. An information handling system may include a bendable or foldable display for displaying user output and receiving user input.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 illustrates a flexible display with a curved region subject to varied light output according to an embodiment of the present disclosure;

FIG. 2 illustrates an information handling system with a flexed panel region subject to varied light output according to an embodiment of the present disclosure;

FIG. 3 illustrates a block diagram of an information handling system enabled to function according to an embodiment of the present disclosure;

FIG. 4 illustrates components of a display including a flexed region that is subject to varied light output according to an embodiment of the present disclosure; and

FIG. 5 illustrates a flow diagram of a processor-based method for varying light output in a flexed portion of a display according to an embodiment of the present disclosure.

### DETAILED DESCRIPTION

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings. The use of the same reference symbols in different drawings indicates similar or identical items.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Information handling systems use displays to interface with users. For displays made of flexible materials, a display may fold inward (i.e., hiding portions of the display surface while folding), may fold outward (i.e., include display surfaces facing in opposite directions), or may otherwise flex during use. For such flexible displays, information presented in a flexed region may appear degraded compared to non-flexed regions. When the display screen, such as a flexible AMOLED in an example embodiment, is flexed at regions near folds, compression and stress is applied to the flexible display screen. This can cause color distortion and may be particularly noticeable where stress is highest. Accordingly, disclosed embodiments control display data to regions of a display that may be flexed or bent (i.e., in a flexed state) to help prevent any degradation of a displayed information that may temporarily occur in flexed, bent, or stressed regions. This avoids irregularities that may otherwise occur due to strains on the materials used to provide the light in the displays. Disclosed embodiments detect stress in flexed (e.g., stressed, curved, hinged, or bent) portions of a display, estimate the amount of stress (e.g., hinge angle, degree of bend, etc.) in affected regions, create a stress map for the display based on the stress data, apply corrections to color mappings (e.g., a color mapping including color, brightness, and texture data) for the display based on the stress map, and provide corrected display data for the affected area. In an example embodiment, sub-pixels within a stressed region may get combined to compensate for distortion in color or the images due to compression of the display screen. This results in consistent display output across bent and straight regions.

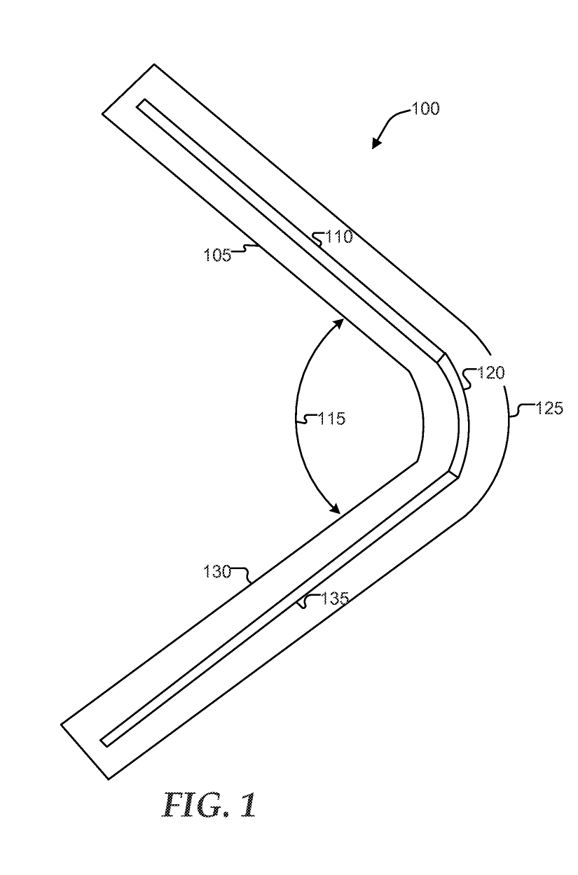

FIG. 1 illustrates flexible display panel 100 according to an embodiment of the present disclosure. As shown, display panel 100 includes a flat display panel 110 oriented at a flex angle 115 compared to flat display panel 135. Flexed panel temporarily curves within curved region 125. Depending on the makeup of flexed panel 120 and the amount of flex in the panel, tight emanating from the panel may be shifted in color or brightness. For example, the hue or brightness of panel 120 may be changed as flex angle 115 increases or decreases. In accordance with disclosed embodiments, a color mapping associated with display panel 100 is changed to result in the light from flexed panel 120 appearing consistent with light from straight regions 105 and 130.

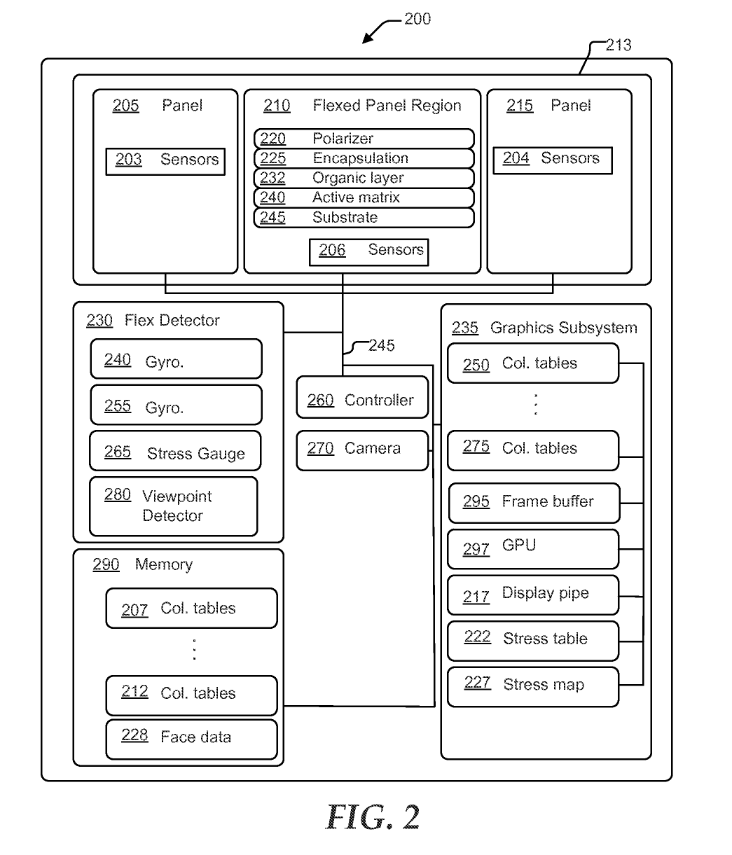

FIG. 2 illustrates information handling system 200 with display 213 that is enabled according to the present disclosure. As shown, information handling system 200 includes panel 205, panel 215, and flexed panel region 210. Each of these panels is communicatively coupled to controller 260 and graphics subsystem 235. Controller 260 and graphics processor unit (GPU) 297 are processors enabled for executing machine-readable instructions to carrying out methods and systems according to disclosed embodiments.

Graphics subsystem 235 includes color tables 250 through 275 and provides display data for display on panel 205, panel 215, and flexed panel region 210. In accordance with disclosed embodiments, graphics subsystem 235 changes graphics data used for flex panel region 210 based on stress data provided by flex detector 230. In an example embodiment, color shift or color offsets in the flexed region may take place. In other example embodiments, sub-pixels may be combined to account for color distortion. In yet other embodiments, brightness of pixels in flexed regions may be altered to accommodate distortion due to compression or stress.

Flex detector 230 is a module that estimates an amount of stress (e.g., bend, flex, fold, etc.) in flexed panel region 210. In various embodiments, the amount of stress can be determined using combinations of instruments and transducers such as gyroscope 240, gyroscope 255, stress gauge 265, and viewpoint detector 280. In an embodiment, viewpoint detector emanates infrared light toward a user's eye and looks for a reflection from the user's pupil to estimate the viewing angle of the screen. In some embodiments, infrared light enters the eye and is reflected or re-emitted by the retina and detected by a receiver of viewpoint detector 280. The reflected light makes the pupil appear “brighter” (in the invisible spectrum to humans) to the receiver. Controller 260 in conjunction with viewpoint detector 280 include software that acquire video information from the user's eyes, digitize the information, and estimate the location of the user's pupil based on the reflected light.

In some embodiments, gyroscopes 240 and 255 include accelerometers and are installed proximate to (e.g., near, within, under, etc.) panels 205 and 215. As the panels are moved relative to each other, gyroscope 240 and 255 provide data to controller 260, which processes the data to determine the amount of stress in flexed panel region 210. In one scenario, if flexed panel region 210 is a hinged region of display 213, allowing panel 205 and panel 215 to fold inward toward each other, gyroscope 240 and gyroscope 255 determine the degree to which the panels are folded inward. This information is used by controller 260 to determine the amount of flex in flexed panel region 210, to estimate the amount of distortion or degradation that may occur in the affected area, so that corrections may be applied.

In some embodiments, the amount of stress in flexed panel region 210 is measured as an estimated angle between panel 205 and panel 215. As discussed above, the angle between panels can be estimated based on data from gyroscope 240 and gyroscope 255, which are used to track the orientation and location of each panel. In addition or instead, stress gauge 265 may employ bimetallic strips (e.g., sensors 203, 204, and 206) to estimate the degree of stress (e.g., the amount of bend) in panel 205, panel 215, and flexed panel region 210. In embodiments in which sensors 203, 204, and 206 are bimetallic strips, the resistance of each strip can be measured to estimate the amount of stress in various regions of the panels. The sensors may be arranged in a grid and relevant data used to determine the location of bends or stresses in the display panels. In accordance with the disclosed embodiments, the location and degree of stresses in the display are used to determine the location and degree of any corrections) to be applied to a color mapping for the affected areas.

As shown, memory 290 includes color tables 207 through 212. In some embodiments, these color tables include display data (e.g., color data, brightness data) used by display pipe 217 to provide data to panel 205, panel 215, and flexed panel region 210. In various embodiments, the color tables include information for each panel stored per pixel, per zone, or per region. In addition or instead, color tables 250 through 275 can include the same or similar display data. Each of these color tables are illustrated and described as examples and not intended to limit the claimed subject matter.

In a particular embodiment, color tables 207 through 212 and color tables 250 through 275 each contain a color gamut (e.g., with color offsets) for specific stress conditions detected in flexed panel region 210. The various color tables are indexed and selected for a particular operating condition according to the type, amount, and location of stress conditions detected by flex detector 230.

Display pipe 217 processes display data for display 213 including in some embodiments by providing an accumulation and blending of multiple layers of images into a composite image. In an example embodiment, display pipe 217 may be a processor or processor subsystem in the graphics subsystem 235 executing instructions to accumulate or blend images among other functions described herein with respect to the image corrections made according to these disclosures. Video frames stored in frame buffer 295 may be represented by RGB color information, and display pipe 217 is enabled for accessing image frame information from memory. (e.g., memory 290). Controller 260 and GPU 297 execute machine readable instructions to buffer data within memory 290 or other storage. In one embodiment, display pipe 217 sends graphics information and video data with transformed color mapping information for display on one or more portions of panel 215. In addition or instead, controller 260 and GPU 297 execute instructions to perform RGB color mapping, provide RGB data for frame buffer 295, and substitute the RGB data for affected regions in accordance with some disclosed embodiments. GPU 297, controller 260, and the other elements in the Figures are illustrated in simplified form, which is not intended to limit the subject matter of the claims. Accordingly, these components act as memory controllers, perform memory input/output (IO), and so on as required by disclosed embodiments.

As shown in the particular embodiment of FIG. 2, flexed panel region 210 comprises polarizer 220, encapsulation 225, organic layer 232, active matrix 240, and substrate 245. These elements are shown in simplified form, but provide for flexibility (e.g., bending, curving, folding) within flexed panel region 210. Polarizer 220 may include a protective cover glass, or strips of protective cover glass, that allows flexibility. Likewise, substrate 245 may consist of carbon fiber or carbon fiber derived blends that permit a desired level of flexibility. A stress gauge as discussed herein may be located in a case (e.g., a protective outer case) made of carbon fiber (or a carbon fiber blend) and used to indicate stress to a screen or display panel. Organic layer 232 may include active-matrix organic light emitting diode technology. Active matrix 240 may include a TFT film known in the art of flexible displays. Similarly, encapsulation 225 includes film components as known in the art.

Panel 215 and panel 205 include the same or similar components, which are omitted for simplicity and clarity in FIG. 2. In addition or instead, panel 215 and panel 210 may remain unflexed in some embodiments, and panels 215 and 210 may include different lighting components (e.g., different LED layers, LCDs, or other display technologies).

Sensors 203, 204, and 206, in various embodiments, can be any combination of bimetallic strips, bimetallic patches, gyroscopes, accelerometers, transducers, or other elements for detecting the level of stress at locations within display 213. These example sensors are discussed (e.g., as bimetallic strips) for illustration purposes only and not intended to limit the scope of disclosed embodiments. Flex detector 230 and its subcomponents in example embodiments are collections of hardware or software modules executing or including machine readable instructions for carrying out the discussed processes including communicating with sensors 203, 204, and 206 to determine the location and amount of stress in the display panels.

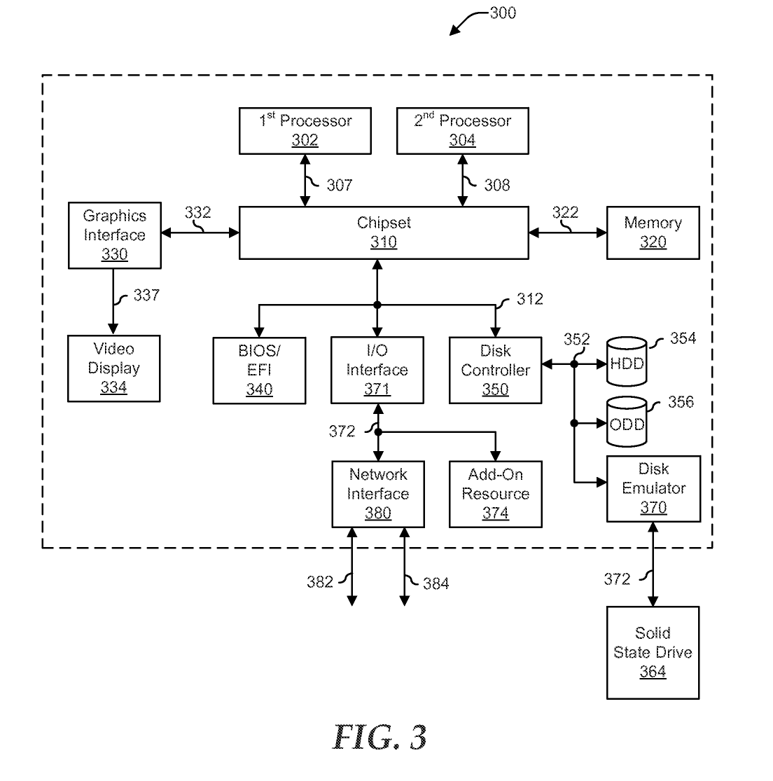

Flexed panel region 210 may be alternately flexed and straight as information handling system 200 is used. In some embodiments, display 213 opens and closes like a paper book, and flexed panel region 210 is analogous to a book binding that also emanates light to form part of a displayed image or page. In addition or instead, flexed panel region 210 may permit a full range of motion (e.g., about 180° motion for each panel) for panels 215 and 205. Flexed panel region 210 is shown for illustration purposes only and is not intended to limit claimed subject matter. Embodiments can include displays that generally fold open and closed like a book (with the operative portion on the inside when closed), have flexible characteristics similar to a blanket (with flexibility in every direction, rather than at a substantially hinged point), or flexibility characteristics similar to a thin piece of plastic (e.g., generally bendable). Such displays may be part of information handling systems, an example of which is described with reference to FIG. 3.

FIG. 3 illustrates a generalized embodiment of information handling system 300. Information handling system 300 can include devices or modules that embody one or more of the devices or modules described above, and operates to perform one or more of the methods described above. Information handling system 300 includes processors 302 and 304, a chipset 310, a memory 320, a graphics interface 330, a basic input and output system/extensible firmware interface (BIOS/EFI) module 340, a disk controller 350, a disk emulator 370, an input/output (I/O) interface 371, and a network interface 380. Processor 302 is connected to chipset 310 via processor interface 307, and processor 304 is connected to chipset 310 via processor interface 308. Memory 320 is connected to chipset 310 via a memory bus 322. Graphics interface 330 is connected to chipset 310 via a graphics interface 332, and provides a video display output 337 to a video display 334. Video display 334 in accordance with disclosed embodiments is flexible or includes a flexible portion. In a particular embodiment, information handling system 300 includes separate memories that are dedicated to each of processors 302 and 304 via separate memory interfaces. An example of memory 320 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 340, disk controller 350, and I/O interface 371 are connected to chipset 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 340 includes BIOS/EH code operable to detect resources within information handling system 300, to provide drivers for the resources, initialize the, and access the resources. BIOS/EFI module 340 includes code that operates to detect resources within information handling system 300, to provide drivers for the resources, to initialize the resources, and to access the resources.

Disk controller 350 includes a disk interface 352 that connects the disc controller to a hard disk drive (HDD) 354, to an optical disk drive (ODD) 356, and to disk emulator 370. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 370 permits a solid-state drive 364 to be connected to information handling system 300 via an external interface 372. An example of external interface 372 includes a USB interface, an IEEE 7194 (Firewire) interface, a proprietary interface, or a combination thereof. Alternatively, solid-state drive 364 can be disposed within information handling system 300.

I/O interface 371 includes a peripheral interface 372 that connects the I/O interface to an add-on resource 374 and to network interface 380. Peripheral interface 372 can be the same type of interface as I/O channel 312, or can be a different type of interface. As such, I/O interface 371 extends the capacity of 110 channel 312 when peripheral interface 372 and the I/O channel are of the same type, and the I/O interface translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as chipset 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can he connected to external network resources (not illustrated). The network resource can include another information handling system, a data storage system, another network, a grid management system, another suitable resource, or a combination thereof.

Processors in disclosed embodiments execute machine instructions stored on a computer readable medium. While a computer-readable medium shown in FIG. 3 may appear in the simplified block diagram as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplar embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

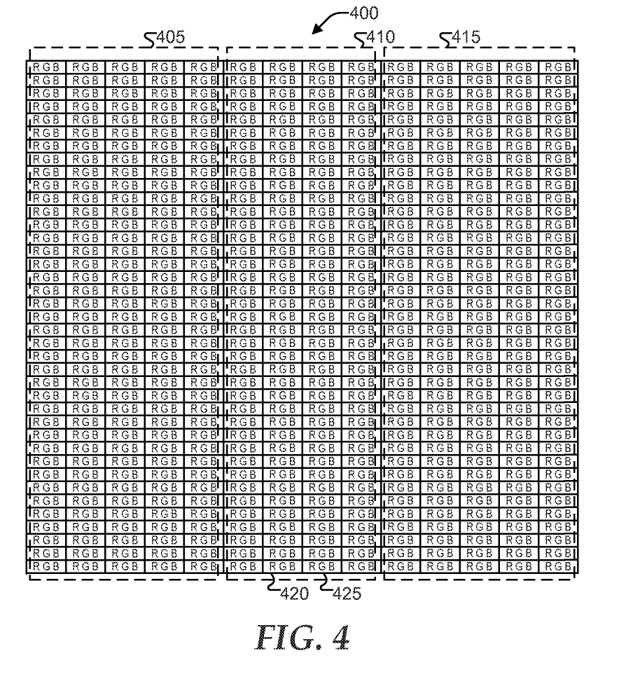

FIG. 4 illustrates display 400 which includes flexed portion 410, non-flexed portion 405, and non-flexed portion 415. As illustrated in FIG. 4, each portion of display 400 is made of numerous pixels including pixels 420 and 425. Flexed portion 410 is affected by a bend, a flex, or a stress, and accordingly pixels within this region may provide undesired color and brightness characteristics. In one scenario, the red-green-blue (RGB) values of pixels 420 and 425 are altered if sufficient stress conditions are detected at the location of pixels 420 and 425. In a particular embodiment, a controller (e.g., controller 260 in FIG. 2) cross references a stress map with a stress table (e.g., stress map 227 and stress table 222 of FIG. 2) to determine how and to what degree to affect pixels 420 and 425. In some embodiments, display data for pixels 420 and 425 are altered using color and brightness offset registers with stored data tables (e.g., in lookup tables) corresponding to a range of stress conditions. Some disclosed embodiments employ data manipulation in which display data is altered through the use of algorithms to produce a re-mapping of data points on a color pallet. This achieves a desired color (e.g., consistent with other non-flexed regions) for a given set of display data for a region affected by flex.

In some embodiments, a stress table stored in a graphics subsystem or other memory includes offset registers with offset values for certain stress conditions. The offset registers may include, as examples, red offset, green offset, blue offset, and brightness offset for various stress conditions. When certain stress conditions are detected, disclosed embodiments access the offset values for those conditions and cause the affected areas to display information with the color and brightness offsets taken into account. Accordingly, in FIG. 4, if a disclosed system detects a stress condition for the location or zone corresponding to pixel 420 or pixel 425, then color mapping data for these pixels is changed to result in the desired display output.

Display 400 as illustrated in FIG. 4 is related to an information handling system that may include a processor and a graphics processing unit (GPU) as discussed herein. Accordingly, pixels 420 and 425 makeup part of a pixel layer comprised of a plurality of color pixels illustrated in FIG. 4. A GPU (e.g., GPU 297 in FIG. 2) controls color characteristics (e.g., color intensity) by selectively altering one or more of the pixels within the pixel layer. This may be achieved, in some embodiments, according to specified red, green and blue gain settings. In addition or instead, a different color gamut in a color table is accessed which corresponds to the stress conditions detected in an affected region.

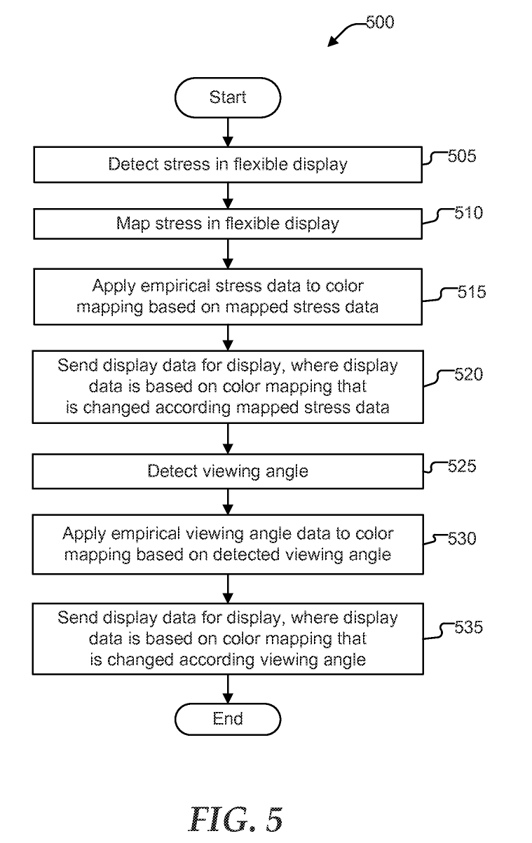

FIG. 5 illustrates display method 500 which is performed according to disclosed embodiments. Method 500 may be performed by some combination of controller 260 (FIG. 2) and GPU 297 (FIG. 2) executing machine readable instructions related to blocks 505-535. Block 505 relates to detecting stress in a flexible display. As discussed, stress may be from flexing (e.g., bending, stressing, folding, etc.) a flexible display. In one scenario, a stress detector (e.g., flex detector 230 in FIG. 2) senses the hinge angle between two flat portions of a flexible display. In FIG. 1, flex angle 115 is the angle between flat display portion 110 and flat display portion 135. Related to block 505, and referring to FIG. 2, gyroscope 240 (FIG. 2) can be located near panel 205 while gyroscope 255 is located near panel 215 to detect relative motion of each panel. In a particular embodiment, 260 executes machine readable instructions to process data from the gyroscopes, to determine a hinge angle between the two panels, based on the estimated orientation and location of each panel. Alternatively, controller 260 (FIG. 2) processes data from stress gauge 265 to determine whether there is stress in flexed panel region 210 (FIG. 2). Accordingly, a processor using data from various flex detector elements (e.g., bimetallic strips, gyroscopes, accelerometers) can be used in the performance of block 505 (FIG. 5).

Block 510 relates to mapping the stress in a flexible display. Mapping the stress can include the degree (e.g., amount) of stress and location of stress. In one embodiment, a stress detector (e.g., flex detector 230) includes a stress gauge (e.g., stress gauge 265) in communication with sensors at known locations within a display panel (e.g., display panel 100 in FIG. 1). For example, sensors 203 and 204 (FIG. 2) may include multiple bimetallic strips at known locations that change their resistance depending upon the amount they are bent. Knowing the location and amount of stress for each sensor, an embodied flex detector maps the stress for a flexible display (e.g., including flexed panel region 210 in FIG. 2) and creates a stress map (e.g., stress map 227 in FIG. 2, which can be a stored army or table) according to block 510.

Block 515 relates to applying empirical stress data to a color mapping based on the mapped stress data. When a flexible display is bent or flexed, the color and brightness for the affected region may change by predictable amounts, based on empirical evidence gathered from similar displays. Alternatively, systems can tune the color gamut used based on user input provided during a test phase of operation, during which empirical evidence is stored.

A bent region of a display may experience a color shift when flexed, resulting in an improper hue of red or other colors shown in the affected region. Accordingly, empirical stress data may be stored in a table (e.g., stress table 222 in FIG. 2) and include color offset data (e.g., the degree a color is expected to change) for certain amounts of stress. The empirical data may relate to a single color, a color gamut, a set of colors, or a subset of colors.

In addition or instead, the empirical data may include brightness offset data, which relates to the degree to which the brightness of an affected region is expected to change based on a level of stress. For example, if the empirical stress data suggests the brightness for an affected region will be decreased by 50% due to stress in a flexible display, an embodied system practicing block 515 (FIG. 5) may alter a color mapping to increase the brightness of the affected region. This scenario regarding 50% brightness is an example embodiment, and reduction or increase of levels may be made according to need for image consistency or other parameters in other embodiments. Similarly, if the empirical stress data suggests, for a given level of stress, that a certain color gamut (e.g., stored in color table 275) should be employed, then an embodied system practicing block 515 (FIG. 5) may access the needed color gamut and index the appropriate colors to the affected areas according to a stress map.

Some embodiments affect a color mapping for a flexible display according the viewing angle of a user. A user looking at a display head-on (while directly in front of the display) would view the display and the affected region at substantially a 0° angle. As the user moves to the side of the monitor at the same distance, the viewing angle increases to a maximum theoretical value of 90° or −90°. As a user's viewing angle changes, he or she may perceive a degradation in the viewing experience, particularly in regions affected by stress, bending, or flexing. Accordingly, block 525 relates to detecting the viewing angle of a user to an affected region (e.g., flexed or bent region) of a display. The viewing angle may be estimated according to data (e.g., distance, orientation, etc.) provided by a depth camera (e.g., camera 270 in FIG. 2). For example, controller 260 (FIG. 2) executes machine readable instructions to process face data received by (e.g., depth camera 270 in FIG. 2) to estimate a viewing angle. A depth camera can be used to build a 2D or a 3D mapping including a user's face, to estimate the viewing angle and distance of a viewer from a display. Distance to a user's face can be judged by camera 270 in conjunction with software executed on controller 260 based on active stereo or time-of-flight sensing. The viewing angle can be estimated, in an example embodiment, by comparing real time face data to stored face data (e.g., empirical data stored in face data 228 in FIG. 2) for known viewing angles. Once the viewing angle is determined, the color mapping for bent, flexed, or stressed areas can be further modified to account for the viewing angle. The process can be performed in real time as the user moves relative to the display.

Block 530 relates to applying the empirical data to a color mapping based on the detected viewing angle. This process is similar to that discussed with respect to block 515. Block 535 relates to sending display data for consumption on the display, where the display data is based on the modified color mapping for the viewing angle. As described above, the color mapping can be changed above based on factors such as the location of stress, level of stress, and viewing angle. Empirical data or filters may be applied based on these factors to affect the color mapping to result in a desired effect, which is often a consistent display of color and brightness across bent and non-bent regions. Additionally, sub-pixels within the flexed regions may be combined to account for image distortion in other embodiments. Graphics subsystem 235 (FIG. 2) may perform block 535 in some embodiments by GPU 297 (FIG. 2) executing machine readable instructions to cause display pipe 217 (FIG. 2) to send display data over bus 245 to flexed panel region 210 (FIG. 2).

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description. Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A display method comprising:
detecting stress in a flexible display;
transforming color mapping data via a controller based at least in part on the elected stress; and
providing display data for display, wherein the display data is based on the adjusted color mapping data.

2. The display method of claim 1, further comprising:
detecting a viewing angle; and
transforming color mapping data based on the detected viewing angle.

3. The display method of claim 1, wherein detecting stress in the flexible display comprises detecting a magnitude and a location of stress in the flexible display.

4. The display method of claim 1, wherein detecting stress in the flexible display comprises using gyroscope data to estimate an angle between a first display panel and second display panel.

5. The display method of claim 1, further comprising:
creating a stress map for the detected stress in the flexible display.

6. The display method of claim 1, wherein transforming color mapping data includes adjusting brightness based on a detected amount of stress.

7. A display comprising:
a flexed region;
a flex detector for providing flex data; and
a controller for transforming color mapping data for the flexed region based at least in part on the flex data.

8. The display of claim 7, further comprising:
a first display panel; and
a second display panel, wherein the flex data is based at least in part on an angle between the first display panel and the second display panel.

9. The display of claim 7, wherein the flexed region comprises an active matrix organic light emitting diode panel.

10. The display of claim 7, further comprising:
a graphics subsystem comprising the controller; and
a display pipe for providing the transformed color mapping data.

11. The display of claim 7, wherein the flex detector is selected from an accelerometer and a gyroscope.

12. The display of claim 7, wherein the flex detector comprises a bimetallic strip.

13. The display of claim 7, further comprising:
a depth camera, wherein the controller transforms the color map data based on a viewing position measured by the depth camera.

14. A flexible display panel comprising:
a light emitting diode layer emitting colored light based on color map data;
a flex detector for determining a flex amount of a flexible region; and
a graphics subsystem:
providing a first portion of the color map data for the flexible region, wherein the first portion of the color map data is based at least in part on the flex amount; and
providing data for a second portion of the color map data for display on a non-flexed region.

15. The flexible display panel of claim 14, wherein the light emitting diode layer is an active matrix light emitting diode layer.

16. The flexible display panel of claim 14, wherein providing the first portion of the color map data is at least in part for affecting a brightness of the flexible region based at least in part on the flex amount.

17. The flexible display panel of claim 14, wherein the flex detector is selected from an accelerometer and a gyroscope.

18. The flexible display panel of claim 14, wherein the flex detector comprises a stress gauge.

19. The flexible display panel of claim 14, further comprising:
a depth camera for detecting viewpoint data.

20. The flexible display panel of claim 14, wherein the graphics subsystem further:
creating a stress map to index the flex amount to the flexible region; and
apply a color offset to the first portion of the color map data based at least in part on the stress map.
